(19) United States
(12) Patent Application Publication
(10) Pub. No.: US 2007/0251326 A1
(43) Pub. Date: Nov. 1, 2007

(54) PRESSURE SENSITIVE CABLE DEVICE FOR MONITORING ROCK AND SOIL DISPLACEMENT

(76) Inventor: James I. Mathis, Ellensburg, WA (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/164,806

(22) Filed: Dec. 6, 2005

Related U.S. Application Data
(60) Provisional application No. 60/634,497, filed on Dec. 8, 2004.

(51) Int. Cl. G01B 5/30

(52) U.S. Cl. 73/760

(57) ABSTRACT

The present invention is a substance displacement device. The device includes a sensing unit which is positioned in a drill hole or otherwise within the substance, such as soil or rock. A measurement device is connected to the sensing unit to measure changes in resistance caused by deformation of the sensing device. A control device connected to the measuring device determines whether the change in resistance exceeds a threshold, and thus activates an alarm. The sensing device preferably includes a fixed resistance device across its terminations to enable the establishing of a baseline resistance. The sensing device may include an electrical element or an optical element. The alarm can be any suitable type of alarm.

### CROSS-REFERENCE TO RELATED CASES

This applicant claims the benefit of U.S. Provisional Patent Application No. 60/634,497 filed Dec. 8, 2004, which is hereby incorporated by reference herein in its entirety.

### BACKGROUND

1. Field of the Invention

This invention relates to the improvement of event detection capabilities for cable monitoring devices installed in geotechnical materials, utilizing both time domain reflectometry (TDR) and electrical resistance principles.

### BACKGROUND

2. Description of Prior Art

Time Domain Reflectometry, or TDR, is a remote sensing electrical measurement technique that has been used for many years to determine the spatial location and nature of various objects. An early form of TDR, dating from the 1930s, that most people are familiar with is radar. The type of TDR most commonly referred to by the acronym in the industry is coaxial TDR. Coaxial TDR is essentially a “closed circuit radar”. It involves sending an electrical pulse along a coaxial cable and using an oscilloscope to observe the echoes returning back to the input. This technique was reported in the literature in the 1930's and 40's for testing telephone coaxial cables. Numerous TDR articles and books have been written on the subject since.

TDR has been actively investigated by both government and private enterprise for uses in monitoring mining induced displacements in the geologic mass surrounding the mine. US Bureau of Mine research was started in the 1960's, when TDR was primarily used to locate breaks in electrical power cables. Since then, use of the method has expanded, but has still not reached its full potential in the field.

If a geologic material is subject to excess stress, whether generated by natural events (excess rainfall, earthquakes, etc), or by human events (excavation) it displaces to equilibrate this excess stress. This will result in discrete displacement (failure along a plane) or distributed displacement within the geologic mass. TDR cable monitoring is generally conducted by placing a TDR capable cable in a drill hole in the geologic mass. Prior to installation, the cable may be crimped to provide reference reflections in the cable at known physical locations in the rock mass. After crimping, the cable is attached to an anchor, lowered down a borehole, and bonded to the surrounding rock with a cement grout. At locations where progressive geologic movement is sufficient to fracture the grout, cable deformation occurs that can be monitored with a TDR cable tester.

This technique has been tested at Syncrude Canada, amongst others. Syncrude operates an oil sand mine in northern Alberta, Canada. The oil sand is mined by large draglines, which operate adjacent to the edge of a highwall that varies in height from 40 to 60 m. Coaxial cables were installed in vertical holes at three highwall locations in the immediate vicinity (less than 10 m) of slope inclinometers so that a comparison could be made between the two types of instrumentation. The objective of these installations was to assess the ease or difficulty of installation, suitability to field conditions, ease or difficulty of data acquisition, comparison with existing monitoring procedures, and sensitivity of TDR to slope movements.

In addition to the field study, an extensive laboratory test program was implemented to correlate TDR reflection magnitude with shear deformation of grouted cables.

It was concluded that TDR represented a promising technology for slope monitoring, but modifications would be required to increase its sensitivity in oil sands and stiff clay soils. Applications in hard rock mining, such as block caving, indicate that block displacement is sufficiently discrete to shear the cable at distinct points, giving a better response than would be expected in stiff clays. In addition, proper selection of the type of cable to be encapsulated, as well as the encapsulation material (stiffer grout, etc.), can be utilized to increase the system sensitivity to displacement.

Electrical resistance within a cable has been used anecdotally in a somewhat similar fashion as to TDR cable. For the electrical resistance cable monitoring device, loops of varying length of conducting wire are placed in the ground in a borehole, as discussed previously. Being of various lengths, these conductive loops will all extend to differing depths within the borehole. The conductive end of each loop is left extending from the top of the borehole such that an electrical signal can be transmitted through the cable.

As for the TDR cable, deformation of the earth results in deformation of the cable. After sufficient deformation has been attained, the cable loops extending below the line of ground deformation are sheared, resulting in a dead open circuit with no signal transmission. Those loops that are intact above the line of ground deformation within the borehole still conduct a signal. By measuring the electrical resistance readings, once can ascertain approximately at what depth the ground is experiencing deformation, as those loops extending below the level of ground displacement will show either a high, or an infinite, resistance.

There does not appear to be any relevant patented, or non-patented, references noted for the system proposed herein. The references relate either to TDR devices or resistance devices as stand alone systems.

### SUMMARY

In view of the insufficiencies discussed above, it is an object of the present invention to provide a pacifier assembly having a cover movably mounted to the shield.

It is a further object of the invention to provide a pacifier assembly which can protect the nipple of the pacifier and which decreases the inconveniences derived from the pacifier falling on the floor.

The present invention is a substance displacement device. The device includes a sensing unit which is positioned in a drill hole or otherwise within the substance, such as soil or rock. A measurement device is connected to the sensing unit to measure changes in resistance caused by deformation of the sensing device. A control device connected to the measuring device determines whether the change in resistance exceeds a threshold, and thus activates an alarm.

The sensing device preferably includes a fixed resistance device across its terminations to enable the establishing of a baseline resistance. The sensing device may include an electrical element or an optical element. The alarm can be any suitable type of alarm.

Other features and advantages of the invention will be apparent from the following detailed description taken in conjunction with the following drawings.

### DRAWING FIGURES

In the drawings, closely related figures may have the same number but different alphabetical suffixes.

FIG. 1 shows the general configuration of the cable monitoring system installed in a geologic material.

FIG. 2 shows a detailed cross section axially along the borehole as depicted in FIG. 1 with a single sensor cable.

FIG. 3 shows the general configuration of the cable monitoring system installed in a geologic material with a multiple strand sensor.

FIG. 4 shows a detailed cross section axially along the borehole as depicted in FIG. 3 showing a multiple sensor cable.

FIG. 5 shows the general configuration of the cable monitoring system installed in a geologic material for a convoluted conduit/external TDR cable.

FIG. 6 shows a detailed cross section axially along the borehole as depicted in FIG. 5 showing the convoluted conduit shrouded cable and external TDR monitoring cable.

FIG. 7 shows a detailed diametric cross section of the borehole with the convoluted to shroued cable and external TDR monitoring cable.

FIG. 8 shows, in axial section, the convoluted cable enshrouding the sensor cable prior to deformation of the shroud.

FIG. 9 shows, in axial section, the convoluted cable enshrouding the sensor cable post deformation of the shroud.

FIG. 10 depicts a cut and fill mining system with the backfilled mining room between two rock pillars. Monitoring system installed to detect shear between fill and pillars.

FIG. 11 depicts a sectional view of a surface mount of the monitoring cable system on a rock face.

FIG. 12 depicts an alternative configuration of the pressure sensitive resistant device that mau be used as a portion cable monitoring system.

### REFERENCE NUMERALS IN DRAWINGS

The following reference numerals are found in the drawings and have the indicated designations:
101 geologic material (rock or soil)
102 locus of ground dislocation
103 pressure sensitive cable (resistance varying)
104 resistor
105 resistance measurement apparatus
106 resistance measurement and alarm controller
107 alarm circuit
108 coaxial cable
109 ----
110 a controller/ID/resistance-measuring device
111 electrical lead
112 electrical lead
113 ----
114 multiple device controller
115 backfilled stopes (mining rooms)
116 underground openings above mining areas
117 underground openings below or adjacent to mining areas
118 surface anchor (mechanical or adhesive)
119 electrical bus
120 global representation of pressure sensitive ground motion system
121 ----
122 ----
123 ----
124 ----
128 ----
129 ----
130 convoluted conduit
131 grout
132 open annulus between outer conduit and inner cable
133 impingement of conduit on sensor 103
134 anchor device
135 borehole in geologic material
136 standard coaxial cable
137 shroud or protective covering
139 water and/or gas resistant membrane
140 water sealing end cap
141 ----
142 deformation of outer conduit upon ground displacement
143 ----
144 conductor
145 dielectric

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

A sensor with electrical resistance properties that vary as a function of pressure is placed within, or upon, a rock, soil, or man made material. The sensing portion of the device may be located within the material, such as being cast in place, placed within a drillhole, or placed in a trench. The sensing portion of the device may also be placed on the surface of the material to be monitored.

The device consists of a measurement unit, a sensing unit, and a control device. The sensing unit is any device such that when subjected to pressure/deformation results in a change in measurable resistance, either optical or electrical. As such this device must at some point form a complete circuit. For the electrical case, this can be prior to the sensing unit being subjected to pressure, where two conductors are connected via a diode, resistor, encoded electrical identifier or other component. This connection may also be created by the application of pressure resulting in a connection between conductors, either by direct contact or through a material which changes conductance with a change in pressure. For the optical case, physical impingement upon the transmitting media results in dissipation and absorption of light such that a received light pulse in a perturbed sensor will be less than a light pulse received in a sensor which has not been disturbed, which is in effect a resistance. In either case, this sensing device is connected to a resistance measurement unit. The resistance measurement unit is connected to a control device. The control device monitors the resistance of the sensor device. When the control device detects a resistance that exceeds the alarm level thresholds the connected alarm device is triggered.

The apparatus may be configured such that it incorporates a single sensing unit, or multiple sensing units connected via a conducting cable (coaxial, twisted pair, etc). A multiple device apparatus may consist of shorter segments of sensors attached to a conducting cable that is connected to a resistance measuring apparatus and alarm controller. Said controller/measurement unit monitors each shorter segment as an individual sensor. In this manner, sections of the geologic material can be monitored for movement instead of using a single device of greater length. This allows greater sensitivity and broadened usage.

In either case, displacement of the geologic material in which a sensor is encapsulated, or is attached to, triggers a resistance change in said sensor at the point of ground dislocation, placing the sensor in shear, tension, or compression. A measurement circuit in the controller detects a resistance change within a sensor. If said resistance change is above a predetermined limit, an alarm device may be triggered. Said alarm device may consist of radio transmission to a base station, flashing lights, stench gas, or whatever alarm is required to provide adequate alert of ground motion.

The device may be utilized in a stand-alone mode such that ground dislocation can be noted at surface. Alternatively, a sensor may be placed in parallel with a TDR (coaxial, twisted pair, etc) or OTDR (fiber optic, single mode, multimode, etc.) capable cable, or the sensor itself may be interrogated with TDR, OTDR, or resistance techniques. This allows detection of the actual location of ground movement along the length of the sensing unit downhole.

Note that an important aspect of the sensor unit is the inclusion of a fixed resistance device across the termination of any individual pair of monitoring strains. By providing such a constant, measurable resistance downhole, a baseline resistance can be determined for the senor. Any shear or short of the monitoring strands within the circuit will change the resistance of the sensor unit circuit. By this means, even standard coaxial cable can become a sensor unit, simply by installing a resistor of known capacity across the terminus of the cable between the inner and outer conductors.

Turning now to the drawings where FIG. 13 is a block diagram representation of electronic components 1000 comprising the present invention, a central processing unit (CPU) 1002 communicates with random access memory (RAM) 1004, electrically erasable and programmable read only memory (EEPROM) 1006, analog to digital converter (ADC) 1008, and input output register (IO) 1010. A real time clock oscillator 1022 may be used to form a real time clock-calendar by means of a program running upon said CPU. A communication interface 1020 may communicate with device 1000 for purpose of allowing commands and parameters to be input to the device to allow performance of the device to be altered by an operator. The device monitors a sensor 1018 to determine if predetermined conditions are met for an alarm. A method of allowing an operator to attach an alarm is provided by alarm relays 1012 and state of predetermined alarm conditions may be indicated to an operator by alarm indicators 1014. A separate switchable relay power supply 1016 may be included to power relays. Said the CPU may disable relay power supply 1016 to save power when relays are not being actuated.

Turning now to FIG. 14, which is a flowchart representation of a program that may run upon CPU 1002, program starts at 1024 and continues on to 1026 where variables and input output ports are initialized. Program continues to 1028 where a decision is made as to whether a command has been received by means of communication through 1020 and if communication has been received, processes commands received in said communications at 1029 and then returns to 1028 to wait for further commands. If no command is received, program continues to 1030 where a low power mode is entered and processing is suspended but program is not exited. An interrupt routine 1042 triggered by means of 1022 causes processing to resume and at 1044 a decision is made as to whether processing was caused to resume by a clock tick. If a clock tick caused resumption of processing, program continues to 1046 where clock registers are updated and then on to 1048 where processing is suspended. If a clock tick did not cause suspension of processing, a predetermined time period has elapsed and program continues to 1032 where sensors are read by means of ADC 1008 and a determination is made at 1034 as to whether sensor values are within predetermined bounds. If sensor values are within predetermined bounds, program proceeds to 1036 where relays 1012 are set to states to so indicate; program continues to 1038 where indicators are set to inform an operator that predetermined alarm conditions have occurred; program then continues to 1028. If at 1034 sensor values are outside of predetermined bounds, program continues on to 1040 where relays 1012 are set to states to indicate that no alarming condition has occurred after which program continues to 1041 where indicators are set to indicate that no alarm has occurred after which program continues to 1028.

### Typical Embodiment A

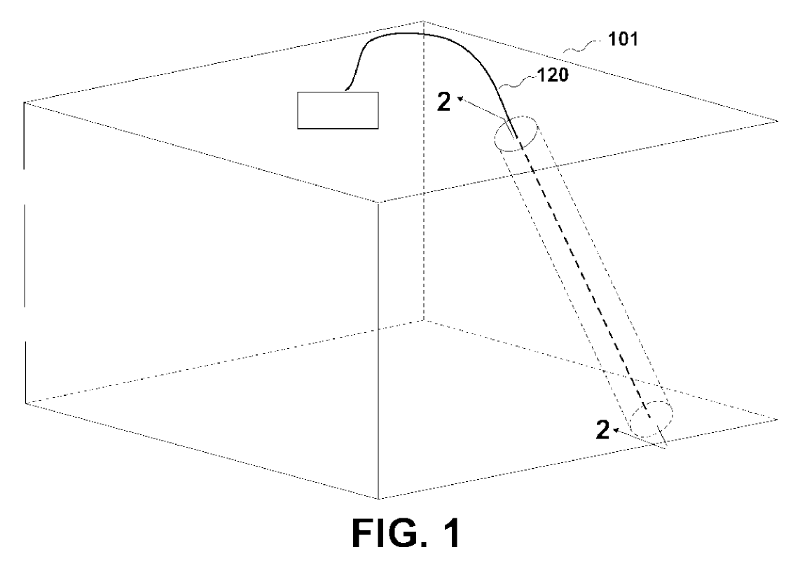

A typical embodiment of the pressure sensitive device for determining if motion is occurring in a geologic material 101 is shown as FIG. 1. The pressure sensitive ground motion detection system, is globally represented as 120 within this Figure.

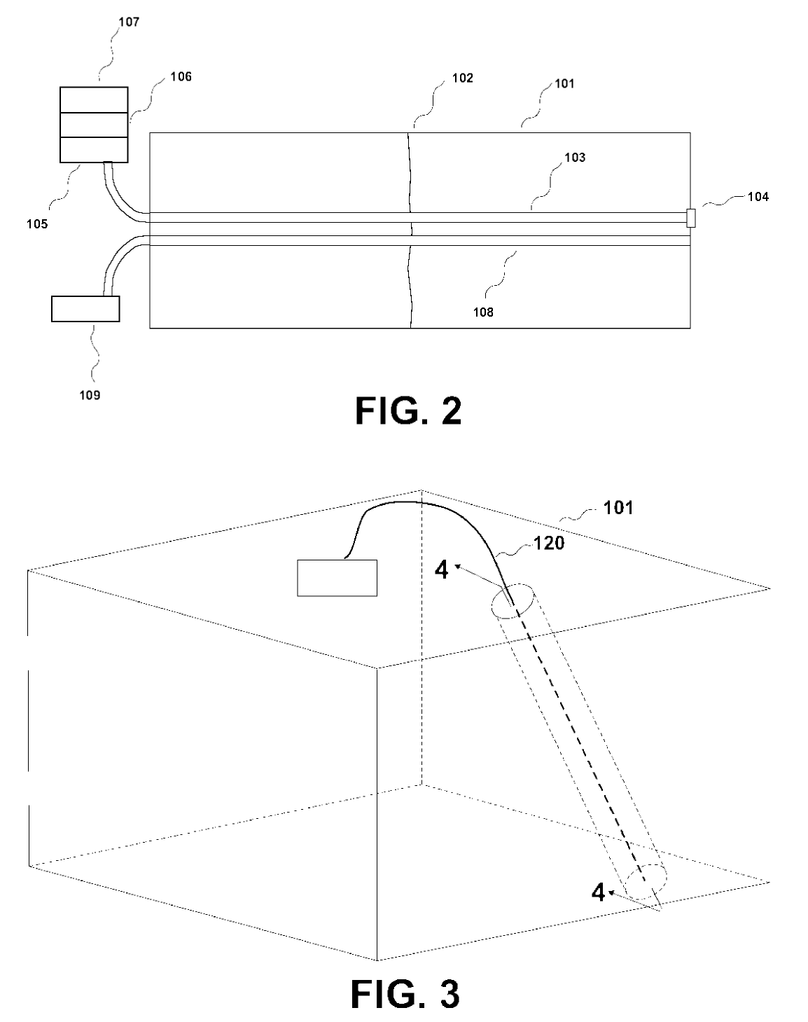

As shown in section in FIG. 2, a cable with electrical resistance properties that vary as a function of pressure (Peratech QTC cable or similar) 103 is placed on or through a rock or soil mass (or man made equivalent) 101. This may be within a drillhole (encased in grout or open), trench (buried or open), or by attachment to the material surface. The cable (sensor) 103 may be furnished with a resistor 104 at the end of said sensor furthest removed from the measuring device. The purpose of 104 is to provide an electrical connection between the two conductors utilized in cable 103 such that a complete electrical circuit is formed with a known resistance so complete cable shear can be detected. Cable 103 is then connected to a resistance measurement apparatus 105. Said resistance measurement apparatus measures electrical resistance presented by sensor 103. A controller 106 determines the interval at which the resistance of the sensor 103 is interrogated. Said controller 106, is programmable such that a trigger resistance level can be set at which point an alarm circuit 107 is activated. Units 105, 106, and 107 are presumed to be battery powered, although they can be powered by any other source of electrical energy. If displacement of the geologic material 101 is sufficient to induce a resistance change in the sensor 103 such that the controller 106 alarm level is exceeded, the alarm circuit 107 is activated. This alarm circuit 107 may consist of electronic transmissions to a base station, triggering of visual or sound alarms (flashing lights, sirens), stench alarms for noisy environments (heavy machine and drilling underground), etc. The sensor 103 may be interrogated by TDR (time domain reflectometry) techniques to determine the point of geologic dislocation (ground motion) 102. Alternatively, a separate, parallel TDR capable cable (coaxial, twisted pair, etc) or OTDR (optical time domain reflectometry) fiber optic cable 108 may be installed together with 103. Cable 108 may also be interrogated by TDR/OTDR to locate the physical point of ground displacement 102. Note also that if the parallel cable 108 is equipped with a terminating resistor 104 downhole, then it may also be described as a sensor 103 and can be monitored in a similar fashion, as may the sensor 103 depending on its configuration.

### Typical Embodiment B

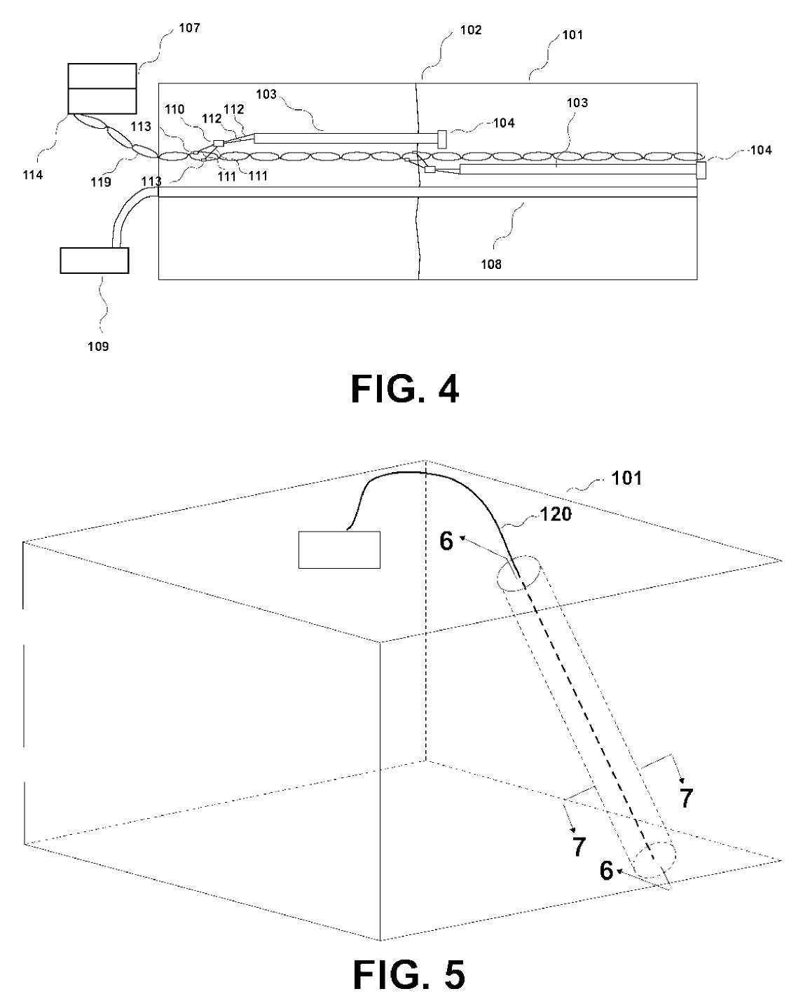

This embodiment is shown in FIG. 3 with a sectional representation in FIG. 4.

It is similar to the first embodiment described with the exception that multiple pressure sensing cables 103 are connected to an electrical bus 119. Said electrical bus may consist of any suitable electrical conductors, with twisted pair or coaxial being preferred. Individual, shorter sections of sensor 103 are connected to the electrical bus by means of electrical leads 111 and 112. Said electrical leads 111 and 112 connect to a controller/ID/resistance-measuring device 110. Said controller/ID/resistance-measuring device associates a unique serial number (ID) with each segment of sensor 103 to which it is attached. When activated by a multiple device controller 114, device 110 determines the resistance of each uniquely identified section of sensor 103. Information obtain is communicated to multiple device controller 114. Multiple segments of sensor 103 may be placed along a specific monitoring line (downhole, in a trench, along a surface) attached to electrical bus 119. This enables a user to determine a specific interval along the monitoring line in which ground motion is occurring, as the multiple device controller can identify, by serial number, which sensor 103 segment has experienced ground motion. Alarm systems, reactions, and TDR/OTDR location of the ground motion from this point onward are consistent with the first embodiment.

The obvious hybrids of the first two embodiments are also disclosed and claimed. These are the connection of electrical bus 110 to a single pressure sensitive device 103, either with, or without, the usage of controller/ID/resistance measuring device 110.

### Typical Embodiment C

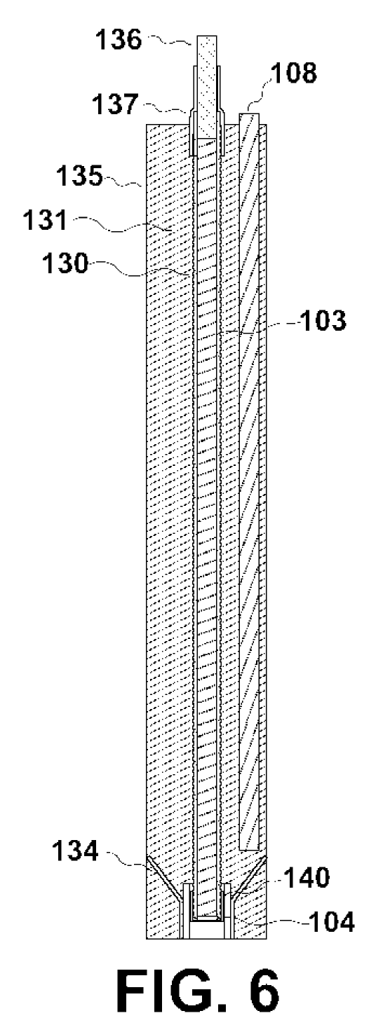

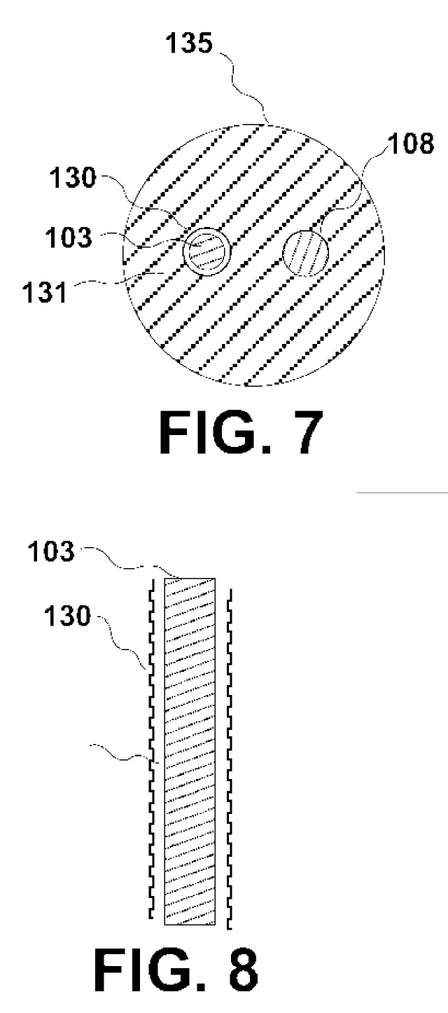

This embodiment is depicted in FIG. 5 with sectional representation in FIGS. 6 thru 9.

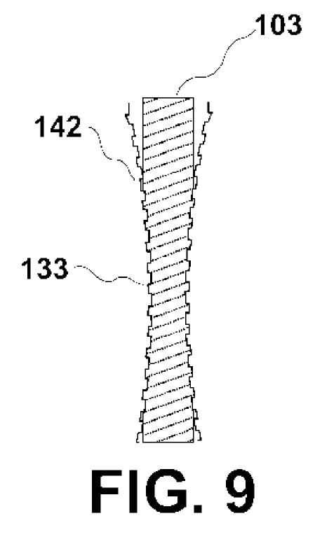

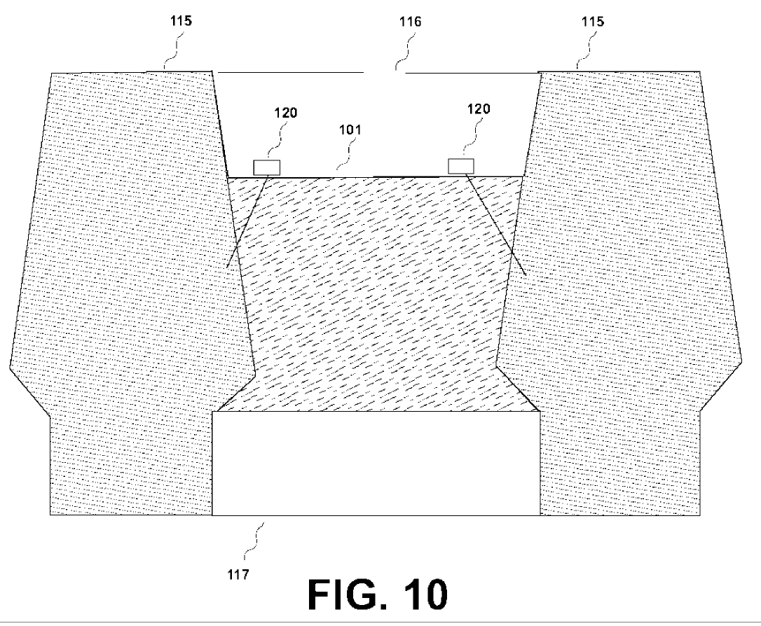

As for the first two embodiments, this depicts the deployment of the pressure sensitive ground motion system 120, in a borehole drilled in a geologic or man made (concrete, etc) environment. A seventh embodiment is depicted in FIGS. 6 thru 9. This embodiment incorporates a any sleeve or tubing, with a convoluted conduit 130 preferred, around the pressure sensitive device 103 shown here encapsulated in a grout 131. The usage of a convoluted conduit is recommended with a user specified open annulus 132, FIG. 8. As the ground deforms, with corresponding conduit deformation 142, annulus 132 closes and convolutions in said conduit impinge 133 on the pressure sensitive device 103, FIG. 9. These impingements increase the local resistance changes resulting in increased cable sensitivity. The downhole end of the conduit is may be equipped with a water sealing end cap 140 to prevent water intrusion into the conduit 130. An anchoring device 134 may be attached to the bottom of conduit 130 and the pressure sensitive device 103 such that the assemblage will remain in place at the bottom of the drillhole. This anchor can consist of a weight, conical plastic diaphragm, deformed spring hooks (as shown), etc, or essentially any means to prevent the cable from displacing from its placed location in the drillhole 135. To prevent local kinking at the collar of a drillhole, pressure sensitive device 103 has been electrically coupled to standard coaxial cable 136. Kinking or damage in this location could produce erroneous readings. A protective shroud 137 has been placed over coaxial cable 136 and conduit 130 to prevent water intrusion into annulus 132. An additional coaxial or fiber optic cable 108 may be placed adjacent to conduit 103 such that it can be utilized as a stand-alone method of monitoring, either for allowing a greater survivable time or greater accuracy in measuring deformation. This embodiment has application for rock faces in mines, highway cuts, etc. as well as soil faces for any excavation. Alarm activation and monitoring is as for the first listed embodiment.

### Typical Embodiment D

This embodiment is depicted in FIG. 5 with sectional representation in FIGS. 6 thru 9.

As for the first two embodiments, this depicts the deployment of the pressure sensitive ground motion system 120, in a borehole drilled in a geologic or man made (concrete, etc) environment. A seventh embodiment is depicted in FIGS. 6 thru 9. This embodiment incorporates a any sleeve or tubing, with a convoluted conduit 130 preferred, around the pressure sensitive device 103 shown here encapsulated in a grout 131. The usage of a convoluted conduit is recommended with a user specified open annulus 132, FIG. 8. As the ground deforms, with corresponding conduit deformation 142, annulus 132 closes and convolutions in said conduit impinge 133 on the pressure sensitive device 103, FIG. 9. These impingements increase the local resistance changes resulting in increased cable sensitivity. The downhole end of the conduit is may be equipped with a water sealing end cap 140 to prevent water intrusion into the conduit 130. An anchoring device 134 may be attached to the bottom of conduit 130 and the pressure sensitive device 103 such that the assemblage will remain in place at the bottom of the drillhole. This anchor can consist of a weight, conical plastic diaphragm, deformed spring hooks (as shown), etc, or essentially any means to prevent the cable from displacing from its placed location in the drillhole 135. To prevent local kinking at the collar of a drillhole, pressure sensitive device 103 has been electrically coupled to standard coaxial cable 136. Kinking or damage in this location could produce erroneous readings. A protective shroud 137 has been placed over coaxial cable 136 and conduit 130 to prevent water intrusion into annulus 132. An additional coaxial or fiber optic cable 108 may be placed adjacent to conduit 103 such that it can be utilized as a stand-alone method of monitoring, either for allowing a greater survivable time or greater accuracy in measuring deformation. This embodiment has application for rock faces in mines, highway cuts, etc. as well as soil faces for any excavation. Alarm activation and monitoring is as for the first listed embodiment.

### Typical Embodiment E

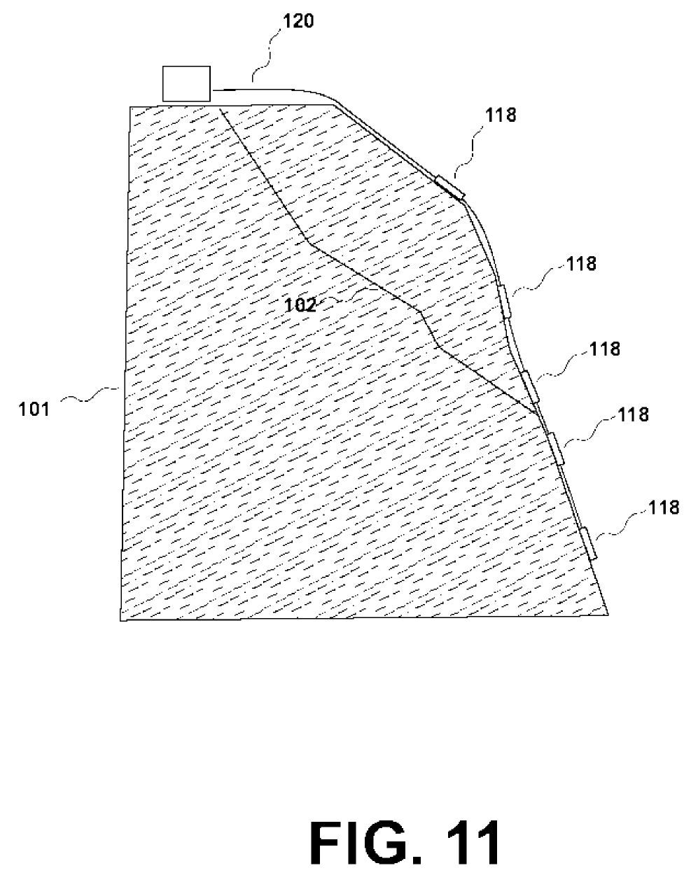

This embodiment, shown in FIG. 11, depicts a surface application of the pressure sensitive ground motion system 120. In this case, the system is deployed on the ground surface over geologic rock blocks or surfaces that may experience motion. Cable 103 is attached to the face by usage of adhesive or mechanical anchors 118, spanning dislocation area 102. Alarm activation and monitoring is as for the first listed embodiment.

### Typical Embodiment F

In this embodiment, the system 120 is deployed with cables 103 being located within a trench or drillholes underneath and area to be monitored. The sensing device 103 may be below a roadway, a housing project, etc. If subsurface subsidence (sinkholes, old mining excavations, etc) begin to break through to surface, they will induce motion in the ground, and thus vary resistance in the sensing device 103, triggering the alarm circuit.

### Typical Embodiment G

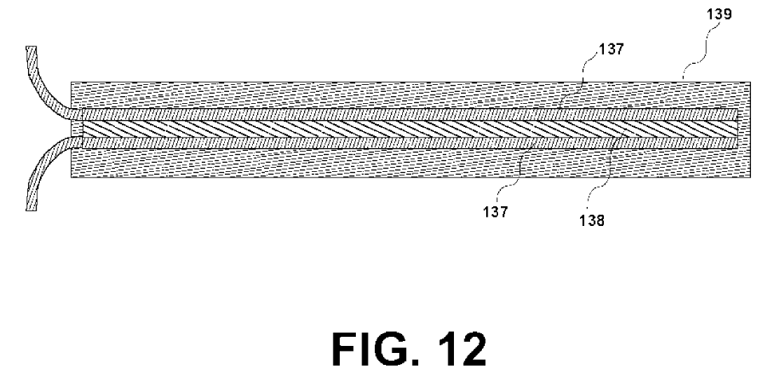

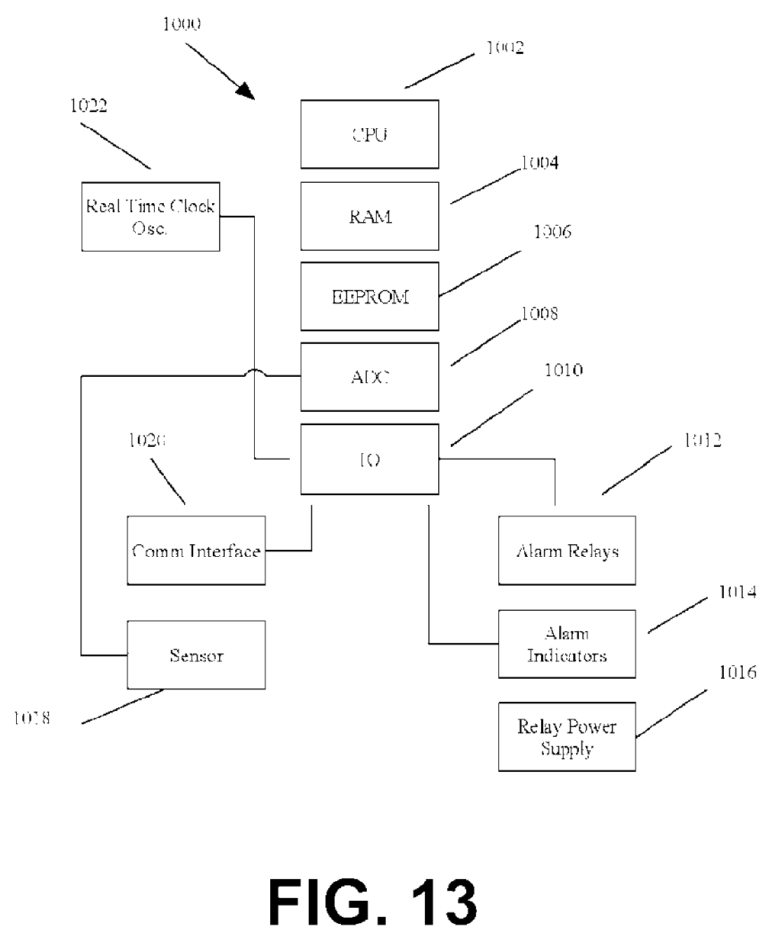

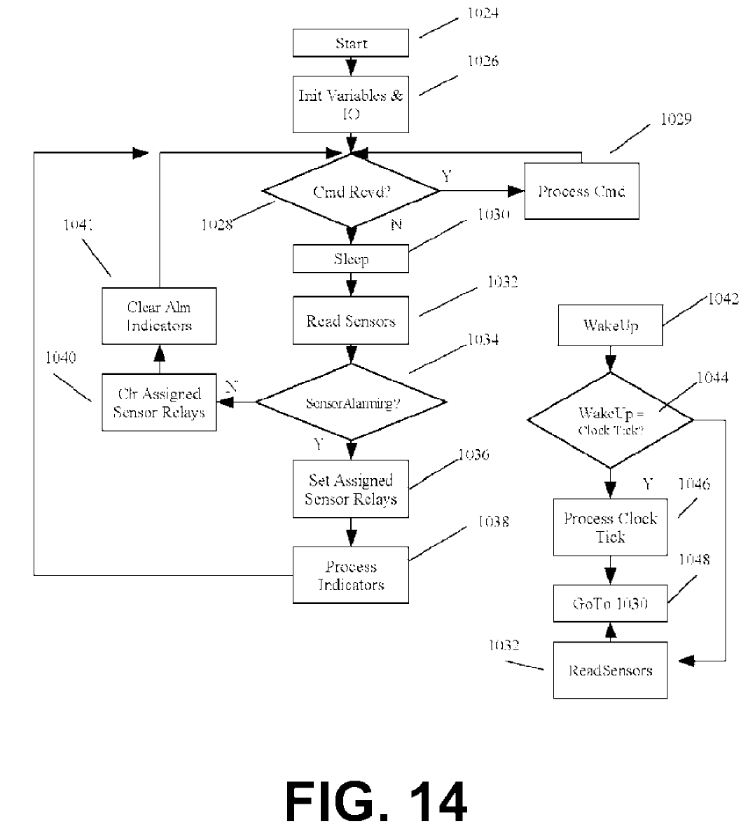

This embodiment demonstrates an alternative method of construction of the pressure sensitive device 103. This is shown in FIG. 12. In this embodiment, the pressure sensitive device 103 consists of a sandwich of two metallic conductors 144 (in this case, copper tape) attached to two sides of a pressure sensitive tape 145 (Peratech QTC tape or pressure sensitive underlay). This composite is then encapsulated in a waterproof sheath 139, consisting of plastic or some other fluid or gas resistant membrane. When said composite structure is subjected to pressure, the electrical resistance of the pressure sensitive tape decreases, resulting in a low electrical resistance pathway between the two conductors 144. Current flow can then be detected through the completed circuit, allowing it to be used as a pressure sensitive device 103. Note also that, as the material is constructed from two conductors 144 separated my a dielectric material 145, that it is possible to locate the distance along the device, at which point electrical bridging is occurring, using standard electrical TDR techniques.

### Typical Embodiment H

Here, the pressure sensitive sensor 103 is be replaced by a length of standard coaxial cable, twisted pair cable, or any other medium that will allow TDR interrogation, with the terminus of the cable pair (for coaxial cable this pair is the inner and outer conductor) is bridged with a resistor 104 of known resistance. A break in the circuit changes the system resistance, resulting in a detectable event for the alarm circuit.

### Typical Embodiment I

A preferred embodiment of the resistance measurement/controller/alarm circuit is described as follows:

In one preferred embodiment of the current invention, CPU 1002, RAM 1004, EEPROM 1006, ADC 1008 and IO 1010 may all be included in a semiconductor chip of a type ATMEGA 32 L manufactured by Atmel Corporation. A crystal of fundamental frequency 32.768 KHz manufactured by ECS CORPORATION may provide real time clock oscillator 1022. Sensors may be of a type described in the body of the patent application (Peratech QTC cable 103 or similar equipped with resistor 104). Alarm relays 1012 may be of a type DS2Y-SL2-DC5V manufactured by Aromat Corporation. Relay power supply 1016 may be of a type MIC2145BMM manufactured by Micrel Corporation and communication interface 1020 may be of a type LMX 9820 manufactured by National Semiconductor Corporation. Alarm indicators 1014 may be comprised of any well-known low power light emitting diode (LED). Any well-known lithium ion battery may provide primary power for entire electronics assembly 1000.

### OPERATION

The operation of the pressure sensitive cable device for monitoring rock and soil displacement is as follows.

The pressure sensitive sensor 103 is constructed and installed as described in any of, but not limited to, the disclosed embodiments. Continuity and system resistance are checked and stored with the resistance measurement device 105 and controller 106. Once this has been verified, the alarm level is set through the controller 106 and the alarm circuit 107. This can be varied from dead short to dead open, or incremental resistance changes in between. The controller 106 then measures the resistance of the circuit at program selected time intervals using the resistance measurement device 106. The measured resistance is then compared in the controller to the pre-programmed levels of resistance change required to trigger the alarm circuit.

If a resistance level is found that exceeds the programmed alarm criteria for measured resistance, the controller 106 immediately conducts a control measurement of the system resistance. If the value once again indicates that the measured value exceeds pre-set resistance values for alarm, the alarm circuit is activated.

Once the alarm circuit is activated, an alarm is initiated. Said alarm may consist of radio transmission to a base station, flashing lights, stench gas, or whatever alarm is required to provide alert of ground motion to targetted personnel.

Upon alert, site personnel may take whatever action is necessary, such as closing areas to operation, etc. The system 120 has been designed such that it may be monitored with a time domain reflectometery (TDR) such that the location of ground displacement may be identified within the sensor 103. This function reduces the necessity of reading the sensors or TDR cables on a frequent basis as monitoring the system resistance accomplishes much of the same function by indicating if ground displacement has taken place.

After the alarm has been triggered, if the sensor 103 is still intact and capable of carrying an electrical signal, the alarm circuit 107 may be reset to a new level encompassing the resistance changes that have already occurred.

It should be noted that in the electrical embodiments of the present invention, means for communication for purposes of control, command, and query may be by the means of personal digital assistance (PDA), such as, for example, of a model Tungsten T2 manufactured by Palm, Inc.

While the specific embodiments have been illustrated and described, numerous modifications come to mind without significantly departing from the spirit of the invention, and the scope of protection is only limited by the scope of the accompanying claims.

What is claimed is:

1. A substance displacement device comprising:
a sensing unit positionable to sense substance displacement,
a measurement unit operatively connected to said sensing unit, and
a control device operatively connected to said measurement unit for activating an alarm in the event the measurement unit detects a change in resistance exceeding a specified threshold.

2. The substance displacement device according to claim 1, wherein said sensing unit further comprises a fixed resistance device across the terminations of an individual pair of monitoring strains within the sensing unit for determining a baseline resistance.

3. The substance displacement device according to claim 2, wherein said sensing unit is an electrical sensing unit.

4. The substance displacement device according to claim 2, wherein said sensing unit is an optical sensing unit.

5. The substance displacement device according to claim 2, wherein said sensing unit comprises a coaxial cable, and wherein the fixed resistance device is connected across the end of the coaxial cable.

6. The substance displacement device according to claim 1, wherein the sensing device includes a pressure sensitive cable which has a varying resistance which changes in response to pressure being applied thereto.
